(19) United States
(12) Patent Application Publication
(10) Pub. No.: US 2013/0004658 A1
(43) Pub. Date: Jan. 3, 2013

(54) METHOD OF FORMING ANTENNA BY UTILIZING GRAPHENE

(76) Inventor: Chung-Yen Yang, New Taipei City (TW)

(21) Appl. No.: 13/537,074

(22) Filed: Jun. 29, 2012

(30) Foreign Application Priority Data
Jun. 30, 2011 (TW) 100123114

(51) Int. Cl. B05D 5/12; B82Y 99/00

(52) U.S. Cl. 427/122; 977/932

(57) ABSTRACT

A method of forming an antenna includes molding a supporting body and coating graphene onto the supporting body according a desired pattern of the antenna. The step of molding the supporting body includes forming the supporting body having a non-planar surface. The step of coating the graphene onto the supporting body according the desired pattern of the antenna includes coating the graphene onto the non-planar surface according to part of the desired pattern of the antenna. After the graphene is coated onto the supporting body and accordingly forms the desired pattern of the antenna, there is no need to perform metallization, sputtering, or chemical plating to have conductive particles adhered to the desired pattern of the antenna.

### BACKGROUND OF THE INVENTION

1. Field of the Invention

The present invention relates to forming an antenna, and more particularly, to a method of forming a carrier with an antenna that is formed by graphene.

2. Description of the Prior Art

Nowadays, due to the technical progress and the trend toward user-friendly commodities, flexible printed circuit boards (FPCBs) are employed by the antenna manufacture in a variety of communication electronic products, such as mobile devices including smart phones, mobile phones, notebooks, tablet personal computers, personal navigation devices (PNDs), global position system (GPS) devices, etc. However, when an FPCB is attached to a non-planar surface, especially a three-dimensional (3D) hyperboloid, part of the FPCB may rise off the non-planar surface because the FPCB can not fit the non-planar surface perfectly. It is more appropriate to use the FPCB in a single curved surface in 2.5-dimensional (2.5D) space, which is between the two-dimensional (2D) planar surface and the 3D space. Therefore, a Laser Direct Structuring (LDS) technique is commonly utilized when it is required to dispose an antenna on the non-planar surface.

The LDS technique is to use special plastics to implement a 3D hyperboloid antenna by three steps, which are injection molding, laser activation, and metallization. Besides reducing sizes of electronic devices, the LDS technique also enhances the communication quality to meet the requirement of modern electronic commodities. However, the LDS technique has certain drawbacks. For example, the process is more complicated, the machine for LDS is expensive, and the supply of special plastics of the antenna carrier body is limited to few suppliers. This increases the manufacturing cost, inevitably.

### SUMMARY OF THE INVENTION

Therefore, it is one of the objectives of the present invention to provide a method of forming an antenna. The method not only has a simple process and is not limited to the special plastics supply, but also meets the requirement of forming the antenna on any geometric surface.

According to an embodiment of the present invention, an exemplary method of forming an antenna is disclosed. The exemplary method includes: molding a supporting body, and coating graphene onto the supporting body according a desired pattern of the antenna.

The method of forming the antenna according to the present invention has the certain advantages over the conventional design. For example, the process is simple, the limitation of the special plastics supply is avoided, the requirement of forming the antenna on any geometric surface is easily met, the specific equipment is not required, the material of forming the antenna is cheap and easily obtained, and metallization for conductivity enhancement is not required, which results in decreasing the thickness of the antenna to facilitate the following process of cladding the antenna. Therefore, the manufacturing cost is greatly decreased, and the method of forming the antenna according to the present invention may be applied broadly to various electronic commodities.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of an exemplary method of forming an antenna according to an embodiment of the present invention.

FIG. 2 is a section view of a carrier with an antenna that is formed by utilizing an exemplary method of forming the antenna according to an embodiment of the present invention.

FIG. 3 is a top view of the carrier shown in FIG. 2.

FIG. 4 is a section view of a carrier with an antenna that is formed by utilizing an exemplary method of forming the antenna according to another embodiment of the present invention.

FIG. 5 is a section view of a carrier with an antenna that is formed by utilizing an exemplary method of forming the antenna according to yet another embodiment of the present invention.

### DETAILED DESCRIPTION

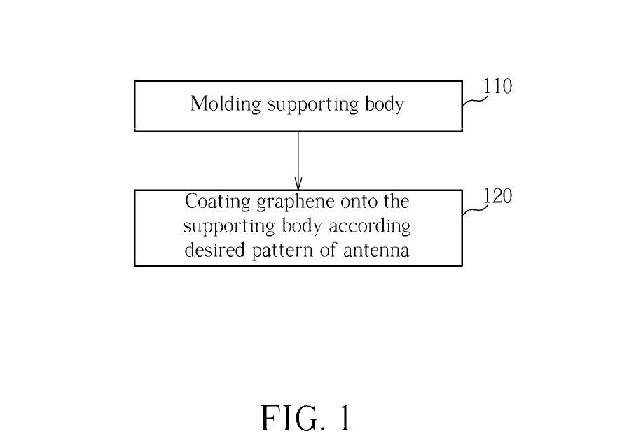

Please refer to FIG. 1, which is a flowchart of an exemplary method of forming an antenna according to an embodiment of the present invention. First, in step 110, a supporting body is molded, where materials of the supporting body may be composed of macromolecular materials or other plastics. Next, in step 120, graphene is coated onto the supporting body according a desired pattern of the antenna. Related details are as follows.

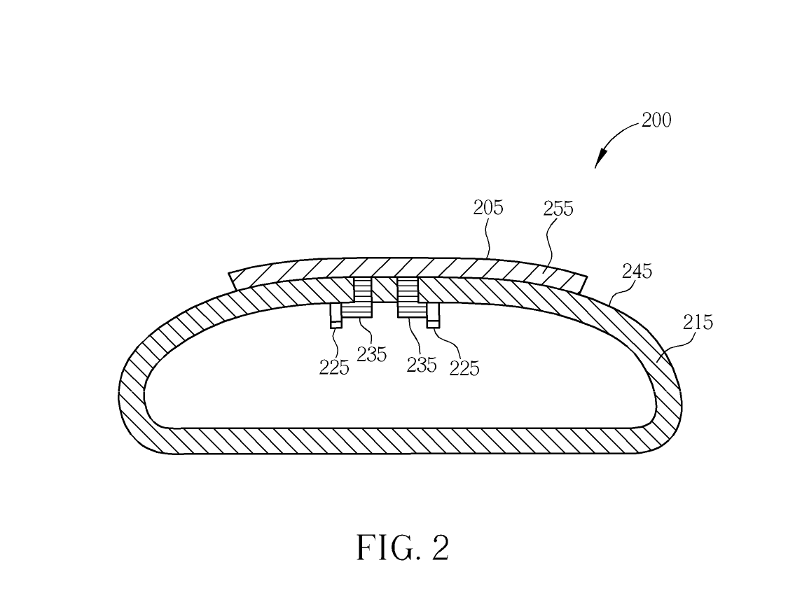

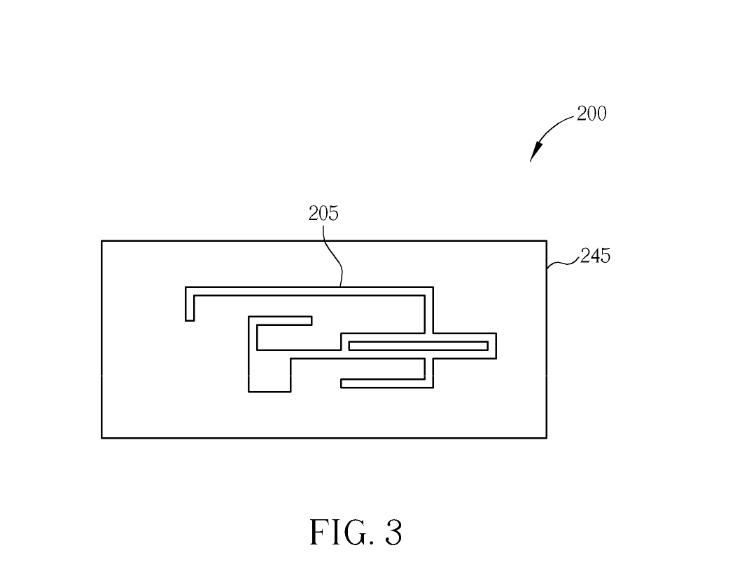

Please refer to FIG. 2 together with FIG. 3. FIG. 2 is a section view of a carrier 200 with an antenna that is formed by utilizing an exemplary method of forming the antenna according to an embodiment of the present invention, and FIG. 3 is a top view of the carrier 200 in FIG. 2. In this embodiment, a supporting body 215 is molded by injection molding, where the supporting body 215 comprises at least a contact object 225, at least a through hole 235, and at least a non-planar surface 245. Next, based on the range of an antenna 205 to be formed on the supporting body 215, graphene 255 is coated onto the non-planar surface 245 to form the antenna 205 according to a desired pattern of the antenna 205 or part of the desired pattern of the antenna 205. While the graphene 255 is being coated onto the supporting body 215, the employed coating method may be spray coating, printing, or painting.

In addition, as the graphene has excellent conductivity higher than that of silver and gold, there is no need to perform extra metallization, sputtering, or chemical plating to have conductive particles adhered to the desired pattern of the antenna after the antenna is formed by the proposed method. Moreover, as the graphene can be easily obtained and can be coated without the use of special equipment, the production cost may be decreased greatly. Furthermore, there is no need to increase the thickness of the antenna for conductivity enhancement, and the graphene is characterized by high hardness, wear-resistance, and high adhesive force, which prevents the graphene from falling off easily even if the graphene is coated on the soft plastics. In a case where the thickness of the antenna is too thick, the following process may have difficulty in forming a coating layer to clad the antenna. Therefore, using the method of forming an antenna according to the present invention may thus facilitate the following process of cladding the antenna. In addition, as the graphene is also characterized by the excellent strong-acid resistance and strong-alkali resistance, the antenna may maintain the excellent quality even if electroless nickel and immersion gold (ENIG) is performed after the antenna is formed.

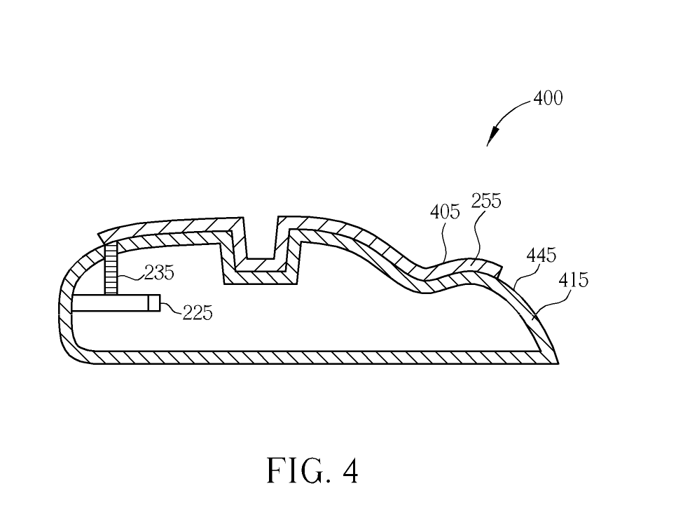

The contact object 225 is electrically coupled to the antenna 205 via the through hole 235. In this embodiment, the non-planar surface 245 is simplified as a smoothly curved surface. In fact, as sputtering and lithography technology are not limited to the geometric surface type of the supporting body, the supporting body may have a combination of planes (e.g., planar surfaces) having at least two normal vectors with a predetermined included angle therebetween. Alternatively, the supporting body may have a combination of planes (e.g., planar surfaces) and curved surfaces (e.g., non-planar surfaces). For example, partial surfaces of the supporting body may be concave, wavy, stepped, and convex. Please refer to FIG. 4, which is a section view of a carrier with an antenna that is formed by utilizing an exemplary method of forming the antenna according to another embodiment of the present invention. The carrier 400 includes a supporting body 415, the contact object 225, the through hole 235, a non-planar surface 445, the graphene 255, and an antenna 405. As shown in FIG. 4, a carrier, having an antenna and including concave or wavy surfaces, may be formed by the exemplary method of forming the antenna according to the present invention. As the implementation steps of the carrier 400 are similar to those of the carrier 200, further description is omitted for brevity.

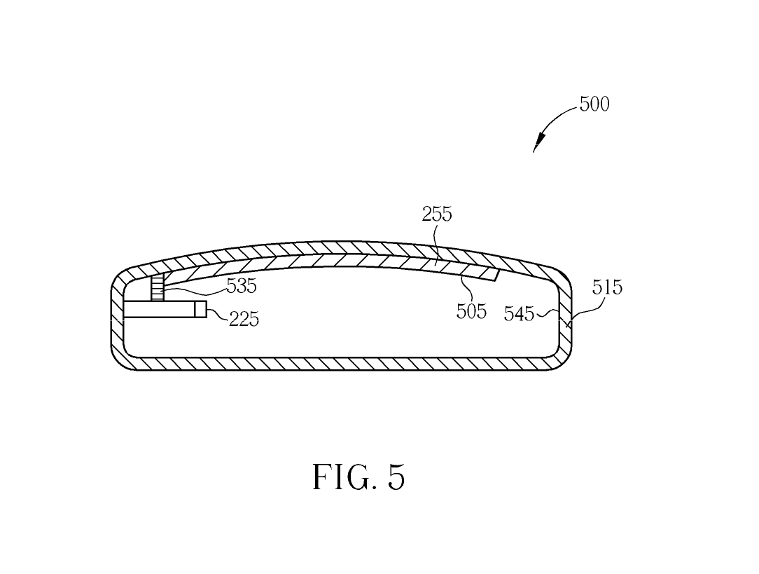

In addition, the method of forming an antenna according to the present invention may also be applied to an inner surface (i.e., a male mold surface). Please refer to FIG. 5, which is a section view of a carrier with an antenna that is formed by utilizing an exemplary method of forming the antenna according to yet another embodiment of the present invention. The carrier 500 includes a supporting body 515, the contact object 225, a contact point 535, a non-planar surface 545, the graphene 255, and an antenna 505. As the method of forming an antenna according to the present invention may be utilized on an outer surface (i.e., a female mold surface) and/or an inner surface, where each of the outer surface and the inner surface mentioned above may be a non-planar surface or a curved surface, the method of forming an antenna according to the present invention thus may meet the requirements of implementing antennas on various 3D curved surfaces. In other words, the method of forming an antenna according to the present invention may be applied to 2D, 3D, or 2.5D surfaces. In addition, as the implementation steps of the carrier 500 are similar to those of the carriers 200 and 400, further description is omitted for brevity.

Please refer to FIG. 2 again. Because the contact object 225 is electrically coupled to the antenna 205, an electrically conductive path is established between an electronic device (e.g., an integrated circuit substrate, a display panel, and a device acting as a signal source) and the antenna 205 when the electronic device is disposed to be electrically coupled to the contact object 225. Therefore, a carrier with an antenna, implemented using the exemplary method of forming an antenna according to the present invention, may be applied broadly to various electronic commodities (e.g., the above-mentioned mobile devices), and a frequency band supported by the formed antenna ranges from 200 Hz to 20 GHz. In addition, when the graphene 255 is sputtered onto the supporting body 215, the through hole 235 may be sealed simultaneously to thereby prevent the carrier 200 from undesired penetration of external moisture or other factors affecting the antenna quality. Moreover, in other embodiments, there may be through holes, reserved for other electronic devices or remained unused due to the process limitation, in the carrier having the antenna formed thereon. Therefore, in a variation of this embodiment, a bonding material (e.g., a macromolecular adhesive) may be used to seal these through holes to ensure the antenna quality.

In summary, the method of forming an antenna according to the present invention has certain advantages over the conventional design. For example, the process is simple, the limitation of special plastic supply is avoided, the requirement of forming an antenna on any geometric surface is easily met, the manufacturing cost is greatly decreased, and there is no hole generated on an outer surface when the antenna is formed on the outer surface of the supporting body. Thus, the proposed method may be applied broadly to various electronic commodities.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of forming an antenna, comprising:
molding a supporting body; and
coating graphene onto the supporting body according a desired pattern of the antenna.

2. The method of claim 1, wherein after the graphene is coated onto the supporting body and accordingly forms the desired pattern of the antenna, there is no need to perform metallization, sputtering, or chemical plating to have conductive particles adhered to the desired pattern of the antenna.

3. The method of claim 1, wherein the step of molding the supporting body comprises:
molding the supporting body having a non-planar surface.

4. The method of claim 3, wherein the step of coating the graphene onto the supporting body according the desired pattern of the antenna comprises:
coating the graphene onto the non-planar surface according to part of the desired pattern of the antenna.

5. The method of claim 3, wherein the non-planar surface is a curved surface.

6. The method of claim 1, wherein the supporting body comprises:
at least a contact object, electrically coupled to the formed antenna.

7. The method of claim 6, wherein the supporting body further comprises:
a through hole, making the formed antenna penetrate through the through hole to electrically couple the contact object.

8. The method of claim 7, wherein the formed antenna penetrates through and seals the through hole to electrically couple the contact object.

9. The method of claim 7, further comprising:
utilizing a bonding material to seal the through hole.

10. The method of claim 1, wherein a frequency band supported by the formed antenna ranges from 200 Hz to 20 GHz.

11. The method of claim 1, wherein the step of coating the graphene onto the supporting body according the desired pattern of the antenna comprises:
coating the graphene onto the supporting body by spray coating, printing, or painting.
